(19) United States
(12) Patent Application Publication
(10) Pub. No.: US 2022/0328827 A1
(43) Pub. Date: Oct. 13, 2022

(54) Negative Electrode for Secondary Battery and Secondary Battery Including the Same

(71) Applicant: SK Innovation Co., Ltd., Seoul (KR)

(72) Inventors: Yong Seok Lee, Daejeon (KR); Sang Won Bae, Daejeon (KR); Myung Ro Lee, Daejeon (KR); Jae Ram Kim, Daejeon (KR); Jung Hwan Kim, Daejeon (KR)

(21) Appl. No.: 17/565,543

(22) Filed: Dec. 30, 2021

(30) Foreign Application Priority Data
Nov. 2, 2020 (KR) 10-2020-0144350

(51) Int. Cl. H01M 4/583; H01M 4/04; H01M 4/36; H01M 4/62; H01M 4/525; H01M 4/505; H01M 4/38

(52) U.S. Cl. CPC H01M 4/583; H01M 4/0404; H01M 4/366; H01M 4/625; H01M 4/622; H01M 4/525; H01M 4/505; H01M 4/386; H01M 2004/027

(57) ABSTRACT

Provided are a negative electrode for a secondary battery including: a current collector; a first coating layer including a point-type conductive material and a binder, formed on the current collector; and a second coating layer including a silicon-based active material, formed on the first coating layer, and a lithium secondary battery including the same.

### CROSS-REFERENCE TO RELATED APPLICATION

This application claims priority to Korean Patent Application No. 10-2020-0144350 filed Nov. 2, 2020, the disclosure of which is hereby incorporated by reference in its entirety.

### BACKGROUND OF THE INVENTION

### Field of the Invention

The present disclosure relates to a negative electrode for a secondary battery and a secondary battery including the same.

### Description of Related Art

Recently, as an issue of global warming arises, a demand for environmentally friendly technologies is rapidly increasing in response thereto. In particular, as a technical demand for electric vehicles and energy storage systems (ESS) increases, a demand for a lithium secondary battery in the spotlight as an energy storage device is exploding. Therefore, studies to improve energy density of the lithium secondary battery are in progress.

However, in a negative electrode of conventional commercialized lithium secondary batteries, a graphite negative electrode active material such as natural graphite and artificial graphite is commonly used, but the energy density of the battery is low due to the low theoretical capacity of the graphite (372 mAh/g), and thus, studies to improve the energy density by developing a new negative electrode material are in progress. As a solution thereto, a Si-based material having a high theoretical capacity (3580 mAh/g) is emerging as one solution. However, the Si-based material as such has a disadvantage of deteriorated battery life characteristics due to large volume expansion (˜400%) in the course of repeated charge and discharge. Thus, as a method of solving the issue of large volume expansion of the Si material, a SiOₓ material which has a low volume expansion rate as compared with Si has been developed. However, due to a side reaction of a Si-based material and an electrolyte solution, there are problems of increased interfacial resistance and deteriorated life characteristics and a problem of reduced electrode adhesive strength due to volume expansion, and thus, there is a limitation in application.

In addition, as a positive electrode, a lithium nickel-based oxide is often used as a positive electrode active material, since it has excellent capacity properties. As a nickel content is increased, it is easy for the lithium nickel-based oxide to be used in producing a high capacity battery, and a study to apply a high nickel-based oxide as a commercial positive electrode is being conducted. However, as the nickel content in the positive electrode active material is increased, structural safety of the positive electrode is reduced, and as a charge C-rate is increased, resistance is increased, and thus, by the two causes, a time point of structural change (M→H2→H3) of the positive electrode is advanced. The results may be confirmed by referring to a structural change depending on a Ni content of a Ni-based positive electrode active material (FIG. 4A of the present specification, source: R. Jung, (BMW) Journal of The Electrochemical Society, 164 (7) A1361-A1377 (2017)) and a graph showing a structural change (dQ/dV inflection point) of a positive electrode depending on a charge C-rate change in a positive electrode active material having a Ni content of 80% or more (FIG. 4B of the present specification).

For solving the problems, development of a lithium secondary battery having excellent fast charge characteristics by improving resistance properties of an electrode is demanded.

### SUMMARY OF INVENTION

### Technical Problem

An embodiment of the present invention is directed to providing increased adhesive strength and improved resistance properties by applying a conductive layer coated with a conductive carbon material on a current collector and applying an active material layer on the conductive layer.

Another embodiment of the present invention is directed to secure long-term fast charging performance of a secondary battery, by decreasing resistance of a positive electrode to which a high nickel-based positive electrode active material is applied to improve a positive electrode structural change during high-rate charging.

### Solution to Problem

In one general aspect, a negative electrode for a secondary battery includes: a current collector; a first coating layer including a point-type conductive material and a binder, formed on the current collector; and a second coating layer including a silicon-based active material, formed on the first coating layer.

A ratio between an average particle diameter (D50) of the point-type conductive material and an average particle diameter (D50) of the silicon-based active material may be 1:60 to 1:20.

The average particle diameter (D50) of the point-type conductive material may be 100 to 200 nm.

The point-type conductive material may include at least one selected from carbon black and graphite-based materials.

The binder may be carboxymethyl cellulose, a carboxymethyl cellulose derivative, polyvinyl alcohol, polyacrylic acid, a polyacrylic acid derivative, or a combination thereof.

The first coating layer may have a thickness of 0.05 to 2 μm.

The average particle diameter (D50) of the silicon-based active material may be 2 to 10 μm.

The second coating layer may further include a carbon-based active material, a binder, and a conductive material.

The negative electrode may further include a third coating layer including a silicon-based active material, formed on the second coating layer.

A content of the silicon-based active material in the second coating layer (wt % with respect to a total weight of the second coating layer) may be higher than a content of the silicon-based active material in the third coating layer (wt % with respect to a total weight of the third coating layer).

In another general aspect, a secondary battery includes: the negative electrode; a positive electrode; a separator disposed between the negative electrode and the positive electrode; and an electrolyte solution.

The positive electrode may include a current collector; a first positive electrode coating layer including a point-type conductive material and a binder, formed on the current collector; and a second positive electrode coating layer including a Ni-based active material represented by the following Chemical Formula 1, formed on the first positive electrode coating layer:

LiₐNiₓCo_{y}Mn_{1-x-y}O₂ [Chemical Formula 1]

wherein a, x, and y satisfy: 0.9≤a≤1.05, 0.80<x≤1, 0≤y<0.2.

A ratio between an average particle diameter (D50) of the point-type conductive material and an average particle diameter (D50) of the silicon-based active material included in the positive electrode may be 1:60 to 1:20.

### Advantageous Effects of Invention

Since a contact between an electrode current collector and an electrode active material layer and a contact between active material particles and a point-type conductive material are not broken even during contraction and expansion of the active material particles in battery operation, electrical conductivity and resistance increase may be improved.

In addition, the electrical short circuit of the active material and the current collector may be minimized while solving a swelling problem occurring when a conventional PVdF-based electrode binder is used.

In addition, the electrode interfacial resistance of a positive electrode and a negative electrode using a high Ni-based (Ni>80 at %) active material and a silicon-based active material may be decreased and long-term fast charging performance of the secondary battery may be improved.

### BRIEF DESCRIPTION OF DRAWINGS

FIGS. 1A and 1B are images of cross sections of a negative electrode and a positive electrode analyzed by a scanning electron microscope (SEM), the positive electrode and the negative electrode being obtained by disassembling a cell after formation, produced in Example 1.

FIG. 2A is a SEM image showing a SiOₓ particle shape and a graph showing a SiOₓ particle distribution.

FIG. 2B is a SEM image of a point-type conductive material used in a conductive layer.

FIG. 2C is a schematic diagram showing how point-type conductive material particles of a conductive layer and negative electrode active material (SiOₓ) particles according to an exemplary embodiment of the present invention are in contact.

FIG. 3 is a graph of a conductive layer of a negative electrode current collector surface and a conductive layer of a positive electrode current collector surface, produced in Example 1, which was analyzed by infrared spectroscopy (IR).

FIG. 4A is a graph showing a structural change depending on a Ni content of a Ni-based positive electrode active material (source: R. Jung (BMW) Journal of The Electrochemical Society, 164 (7) A1361-A1377 (2017)).

FIG. 4B is a graph showing a positive electrode structural change (dQ/dV inflection point) depending on a charge C-rate change, in a positive electrode active material having a Ni content of 80% or more.

### DESCRIPTION OF THE INVENTION

Advantages and features of the present invention and methods to achieve them will be elucidated from exemplary embodiments described below in detail with reference to the accompanying drawings. However, the present invention is not limited to exemplary embodiments disclosed below, but will be implemented in various forms. The exemplary embodiments of the present invention make the disclosure of the present invention thorough and are provided so that those skilled in the art can easily understand the scope of the present invention. Therefore, the present invention will be defined by the scope of the appended claims. Detailed description for carrying out the present invention will be provided with reference to the accompanying drawings below. Regardless of the drawings, the same reference number indicates the same constitutional element, and “and/or” includes each of and all combinations of one or more of mentioned items.

Unless otherwise defined herein, all terms used in the specification (including technical and scientific terms) may have the meaning that is commonly understood by those skilled in the art. Throughout the present specification, unless explicitly described to the contrary, “comprising” any elements will be understood to imply further inclusion of other elements rather than the exclusion of any other elements. In addition, unless explicitly described to the contrary, a singular form includes a plural form herein.

In the present specification, it will be understood that when an element such as a layer, film, region, or substrate is referred to as being “on” or “above” another element, it can be directly on the other element or intervening elements may also be present.

An exemplary embodiment of the present invention provides a negative electrode for a lithium secondary battery. The negative electrode for a secondary battery includes: a current collector; a first coating layer including a point-type conductive material and a binder, formed on the current collector; and a second coating layer including a silicon-based active material, formed on the first coating layer.

The current collector may be selected from the group consisting of a copper foil, a nickel foil, an alumina foil, a stainless steel foil, a titanium foil, a nickel foam, a copper foam, a polymer substrate coated with a conductive metal, and a combination thereof, but the present invention is not limited thereto.

The first coating layer is formed on the current collector, and includes a point-type conductive material and a binder. By applying the point-type conductive material of the first coating layer on the current collector and applying the second coating layer including the silicon-based active material on the first coating layer, increased adhesive strength and improved interfacial resistance properties between the current collector and the active material layer are allowed.

A ratio between an average particle diameter (D50) of the point-type conductive material and an average particle diameter (D50) of the silicon-based active material may be 1:60 to 1:20, preferably 1:40 to 1:50. The point-type conductive material and the silicon-based active material are in contact in an interface between the first coating layer and the second coating layer, in which it is advantageous for improvement of the effect described above that the contact is a point contact. For example, the silicon-based active material contracts and expands during cell charging and discharging, and a contact between the current collector and the second coating layer (active material layer) and a contact between the silicon-based active material and the point-type conductive material may be maintained to suppress a resistance increase and improve electrical conductivity.

As an example, a contact angle between the point-type conductive material and the silicon-based active material may be 100 to 180°, preferably 150 to 180°, and more preferably 170 to 180°. Thus, the effects described above may be further improved.

Meanwhile, the contact angle between the point-type conductive material and the silicon-based active material may be calculated by the following Equation 1:

Contact angle θ(°)=2×cos⁻¹(d₂/(d₁+d₂)) [Equation 1]

wherein d₁ is a silicon-based active material particle size (D50) of the second coating layer, and d₂ is a point-type conductive material particle size (D50) of the first coating layer.

The average particle diameter (D50) of the point-type conductive material may be 10 to 500 nm, 50 to 400 nm, 50 to 300 nm, 90 to 250 nm, or 150 to 200 nm. Though conventionally used point-type conductive material uses particles having a large particle diameter range of 30 nm to 8 μm, in the present invention, a point-type conductive material having a specific average particle diameter distribution is used, thereby satisfying a contact angle and/or an average particle diameter (D50) ratio between the silicon-based active material and the point-type conductive material.

The D50 refers to a particle diameter with a cumulative volume of 50% when cumulated from the smallest particle in measurement of a particle size distribution by a laser scattering method. Here, for D50, the particle size distribution may be measured by collecting a sample for the prepared negative electrode active material particles according to a KS A ISO 13320-1 standard and using Mastersizer 3000 from Malvern Panalytical Ltd. Specifically, a volume density may be measured after particles are dispersed in ethanol as a solvent, using an ultrasonic disperser, if necessary.

The point-type conductive material may include at least one selected from carbon black and graphite-based materials, preferably, may include carbon black. The conductive material may refer to point type particles, that is, spherical particles, elliptical particles, plate-shaped particles, needle-like particles, and the like having an aspect ratio of 1 to 2, and preferably, may be the spherical particles or the elliptical particles.

The binder may be a water-based binder, and specifically, may include carboxymethyl cellulose (CMC), a carboxymethyl cellulose derivative, polyvinyl alcohol, polyacrylic acid, a polyacrylic acid derivative, or a combination thereof. By using a CMC-based binder, a swelling problem of polyvinylidene fluoride (PVdF)-based binder and an increased electrode resistance problem of styrene butadiene rubber (SBR)-based binder may be improved, and also, an electrical short circuit of a second coating layer (active material layer) and a current collector may be minimized, which is thus preferred.

The first coating layer may be produced by mixing the point-type conductive material and the binder in a solvent to produce a slurry for a conductive layer and applying the produced slurry for a conductive layer on at least one surface of the current collector.

Here, the application may be a known application method used in the production of an electrode.

The first coating layer may have a thickness of 0.05 to 2 μm, preferably 0.5 to 2 μm, and more preferably 1 to 1.5 μm. When it is more than the thickness range, energy density may be decreased.

The negative electrode according to an exemplary embodiment of the present invention includes the second coating layer including the silicon-based active material, formed on the first coating layer.

The first coating layer is as described above, and the second coating layer is disposed on the first coating layer, thereby increasing adhesive strength and improving interfacial resistance properties between the current collector and the active material layer.

The average particle diameter (D50) of the silicon-based active material may be 2 to 10 μm or 4 to 6 μm. Within the particle diameter range, a point contact with the point-type conductive material of the first coating layer may be effectively made, and specifically, a contact between the current collector and the second coating layer (active material layer) and a contact between the silicon-based active material and the point-type conductive material are maintained during contraction and expansion of the silicon-based active material in the charging and discharging of a battery, thereby suppressing a resistance increase and improving an electrical conductivity.

The silicon-based active material may be a silicon-based material, for example, Si, SiOₓ (0<x<2), a Si-Q alloy (wherein Q is an element selected from the group consisting of alkali metals, alkali earth metals, Group 13 elements, Group 14 elements, Group 15 elements, Group 16 elements, transition metals, rare earth elements, and a combination thereof, but is not Si), a Si-carbon composite, or a mixture of at least one thereof with SiO₂. The silicon-based active material may be preferably Si or SiOₓ (0<x<2), and more preferably SiOₓ (0<x<2).

The second coating layer may further include a carbon-based active material. In addition, the second coating layer may further include a binder and a conductive material.

A representative example of the carbon-based active material may be crystalline carbon, amorphous carbon, or a combination thereof. An example of the crystalline carbon includes graphite such as amorphous, plate-shaped, flake-shaped, spherical, or fibrous natural graphite or artificial graphite, and an example of the amorphous carbon includes soft carbon or hard carbon, a mesophase pitch carbide, calcined coke, and the like.

The binder of the second coating layer may be a water-based binder. The water-based binder serves to adhere negative electrode active material particles to each other and to attach the negative electrode active material to the current collector well. The water-based binder may be polyvinylidene fluoride (PVDF), polyacrylic acid (PAA), polyvinyl alcohol (PVA), carboxymethyl cellulose (CMC), starch, hydroxypropyl cellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber (SBR), fluorine rubber, various copolymers thereof, and the like, and specifically, the binder may include a binder formed of carboxymethyl cellulose (CMC), styrene-butadiene rubber (SBR), and a mixture thereof.

The conductive material of the second coating layer is used for imparting conductivity to an electrode and any conductive material may be used as long as it is an electronically conductive material without causing a chemical change in the battery to be configured. An example of the conductive material includes a carbon-based material such as natural graphite, artificial graphite, carbon black, acetylene black, ketjen black, and carbon fiber; a metal-based material such as metal powder or metal fiber of copper, nickel, aluminum, silver, and the like; a conductive polymer such as a polyphenylene derivative; or a mixture thereof.

The second coating layer may include 90 to 100 wt %, preferably 90 to 99 wt %, and more preferably 95 to 98 wt % of the negative electrode active material including the silicon-based active material, with respect to the total weight of the solid content.

The negative electrode active material may include the silicon-based active material and the carbon-based active material at a weight ratio of 1:99 to 30:70, preferably 3:97 to 13:87, and more preferably 4:98 to 6:94.

Each content of the binder and the conductive material in the second coating layer may be 0 to 10 wt %, preferably 1 to 5 wt % with respect to the total weight of the negative electrode active material layer, but is not limited thereto.

The second coating layer may be produced by mixing a silicon-based active material and selectively a carbon-based active material, a conductive material, and a binder in a solvent to produce a negative electrode slurry and applying the produced negative electrode slurry on at least one surface of the current collector on which the first coating layer is formed. Here, the application may be a known application method used in the production of an electrode.

The negative electrode according to an exemplary embodiment of the present invention may further include a third coating layer including a silicon-based active material, formed on the second coating layer.

A content of the silicon-based active material in the second coating layer (wt % with respect to a total weight of the second coating layer) may be higher than a content of the silicon-based active material in the third coating layer (wt % with respect to a total weight of the third coating layer). For example, a content ratio between the silicon-based active material in the second coating layer and the silicon-based active material in the third coating layer may be 5:1 to 1.5:1, 3:1 to 1.5:1, or 2:1 to 1.5:1. During battery charging/discharging, when normal and fast life evaluation is performed, life deterioration may be accelerated due to a side reaction of an electrolyte solution and a coating layer on the surface of the negative electrode, and thus, a silicon-based active material content on the negative electrode surface layer (third coating layer) may be decreased, and the silicon-based active material in the second coating layer may be further included to improve life characteristics.

As the silicon-based active material of the third coating layer, a material which may be used as the silicon-based active material of the second coating layer may be applied, and it may be the same as or different from the silicon-based active material of the second coating layer, but the present invention is not limited thereto.

The third coating layer may further include a carbon-based active material, and also, may further include a conductive material and a binder.

Here, as each of the carbon-based active material, the conductive material, and the binder which are further included in the third coating layer, the carbon-based active material, the conductive material, and the binder of the second coating layer may be applied, and each of the materials may be the same as or different from the carbon-based active material, the conductive material, and the binder of the second coating layer, but the present invention is not limited thereto.

Another exemplary embodiment of the present invention provides a secondary battery. The secondary battery includes: the negative electrode; a positive electrode; a separator disposed between the negative electrode and the positive electrode; and an electrolyte solution.

The negative electrode is as described above.

The positive electrode may include a current collector; a first positive electrode coating layer including a point-type conductive material and a binder, formed on the current collector; and a second positive electrode coating layer including a Ni-based active material represented by the following Chemical Formula 1, formed on the first positive electrode coating layer:

LiₐNiₓCo_{y}Mn_{1-x-y}O₂ [Chemical Formula 1]

wherein a, x, and y satisfy: 0.9≤a≤1.05, 0.8<x≤1, 0≤y<0.2.

The current collector may be a negative electrode current collector described above, and any known material in the art may be used, but the present invention is not limited thereto.

The first positive electrode coating layer is formed on the current collector, and includes a point-type conductive material and a binder. By applying the point-type conductive material of the first positive electrode coating layer on the current collector and applying the second positive electrode coating layer including the Ni-based active material represented by Chemical Formula 1 on the first positive electrode coating layer, structural change of the positive electrode using the high Ni-based active positive material may be delayed.

As the point-type conductive material of the first positive electrode coating layer, a material which may be used as the point-type conductive material of the first coating layer of the negative electrode may be applied, and it may be the same as or different from the point-type conductive material of the first coating layer of the negative electrode, but the present invention is not limited thereto.

The binder of the first positive electrode coating layer may be a non-water-based binder, and specifically, it is preferred to include a polyvinylidene fluoride (PVdF)-based binder.

Meanwhile, a ratio between an average particle diameter (D5) of the point-type conductive material and an average particle diameter (D5) of the Ni-based active material included in the positive electrode may be 1:60 to 1:20, preferably 1:40 to 1:50. The positive electrode active material contracts and expands during cell charging and discharging, and a contact between the current collector and the second positive electrode coating layer (active material layer) and a contact between the Ni-based active material and the point-type conductive material may be maintained to suppress a resistance increase and improve electrical conductivity.

As an example, a contact angle between the point-type conductive material and the Ni-based active material may be 80 to 180°, preferably 150 to 180°, and more preferably 170 to 180°. Thus, the effects described above may be further improved.

Meanwhile, the contact angle between the point-type conductive material and the Ni-based active material may be calculated by the following Equation 2:

Contact angle θ(°)=2×cos⁻¹(d₄/(d₃+d₄)) [Equation 2]

wherein d₃ is a Ni-based active material particle size (D50) of the second positive electrode coating layer, and da is a point-type conductive material particle size (D50) of the first positive electrode coating layer.

The average particle diameter (D50) of the point-type conductive material may be 10 to 500 nm, 50 to 400 nm, 50 to 300 nm, 90 to 250 nm, or 100 to 200 nm. Though conventionally used point-type conductive material uses particles having a large particle diameter range of 30 nm to 8 μm, in the present invention, a point-type conductive material having a specific average particle diameter distribution is used, thereby satisfying a contact angle and/or an average particle diameter (D50) ratio between the Ni-based active material and the point-type conductive material.

The first positive electrode coating layer may have a thickness of 0.05 to 2 μm, preferably 0.5 to 2 μm, and more preferably 1 to 1.5 μm. When it is more than the thickness range, energy density may be decreased.

The positive electrode according to an exemplary embodiment of the present invention includes the second positive electrode coating layer including the Ni-based active material represented by Chemical Formula 1, formed on the first positive electrode coating layer.

The first positive electrode coating layer is as described above, and the second positive electrode coating layer is disposed on the first positive electrode coating layer, thereby increasing adhesive strength and improving interfacial resistance between the current collector and the active material layer.

The Ni-based active material may be LiₐNiₓCo_{y}Mn_{1-x-y}O₂ (0.9≤a≤1.05, 0.8<x≤1, 0≤y<0.2), preferably LiₐNiₓCo_{y}Mn_{1-x-y}O₂ (0.9≤a≤1.05, 0.85≤x≤0.95, 0.01≤y<0.2). When a high Ni-based lithium composite oxide having a Ni content of 80 at % or more is used, energy density and a discharge capacity may be significantly improved, but as the Ni content is increased, structural safety of a positive electrode is lowered and a time of structural change is advanced by increased resistance under high rate charge and discharge conditions, and thus, it is difficult to satisfy both a high capacity and fast charging performance. In the present invention, a positive electrode current collector coated with a conductive layer is applied on a positive electrode, and a negative electrode current collector having a conductive layer formed thereon is simultaneously applied on a negative electrode, thereby reducing resistance of the positive electrode to which current is applied, and thus, the structural change of the positive electrode may be delayed even when a high Ni-based positive electrode active material is used, and a time of structural change in high rate charge may be delayed with lowered resistance, thereby improving fast charge characteristics, which has never been expected before.

Meanwhile, in some exemplary embodiments, the lithium composite oxide particles may further include a coating element or a doping element. For example, the coating element or the doping element may include Al, Ti, Ba, Zr, Si, B, Mg, P, Sr, W, La, or an alloy thereof or an oxide thereof. These may be used alone or in combination of two more. The positive electrode active material particles are passivated by the coating or doping element to further improve the stability and life for the penetration of an external object.

The second positive electrode coating layer includes the positive electrode active material, and optionally, may further include a binder and a conductive material.

The positive electrode active material may further include a positive electrode active material known in the art, and for example, it is preferred to use a composite oxide of lithium with a metal selected from lithium cobalt, manganese, nickel, and a combination thereof, but the present invention is not limited thereto.

The binder and the conductive material may be a binder and a negative electrode conductive material as described above, and any known material in the art may be used, but the present invention is not limited thereto.

The separator may be selected from glass fiber, polyester, polyethylene, polypropylene, polytetrafluoroethylene, or a combination thereof, and may be in the form of nonwoven or woven fabric. For example, a polyolefin-based polymer separator such as polyethylene or polypropylene may be mainly used in the lithium secondary battery, a separator coated with a composition including a ceramic component or a polymer material may be used for securing thermal resistance or mechanical strength, which may optionally have a single layer or multilayer structure, and any known separator in the art may be used, but the present invention is not limited thereto.

The electrolyte solution includes an organic solvent and a lithium salt.

The organic solvent serves as a medium in which ions involved in the electrochemical reaction of the battery may move, and for example, carbonate-based, ester-based, ether-based, ketone-based, alcohol-based, or aprotic solvents may be used, the organic solvent may be used alone or in combination of two or more, and when used in combination of two or more, a mixing ratio may be appropriately adjusted depending on battery performance to be desired. Meanwhile, any known organic solvent in the art may be used, but the present invention is not limited thereto.

The lithium salt is dissolved in the organic solvent and acts as a source of the lithium ion in the battery to allow basic operation of the lithium secondary battery and is a material which promotes movement of lithium ions between a positive electrode and a negative electrode. Examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (x and y are natural numbers), LiCl, LiI, LiB(C₂O₄)₂, or a combination thereof, but the present invention is not limited thereto.

A concentration of the lithium salt may be in a range of 0.1 M to 2 M. When the lithium salt concentration is within the range, the electrolyte solution has appropriate conductivity and viscosity, so that the electrolyte solution may exhibit excellent electrolyte performance and lithium ions may effectively move.

In addition, the electrolyte solution may further include pyridine, triethylphosphate, triethanolamine, cyclic ether, ethylene diamine, n-glyme, hexaphosphate triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxyethanol, aluminum trichloride, and the like, if necessary, for improving charge/discharge characteristics, flame retardant characteristics, and the like. In some cases, a halogen-containing solvent such as carbon tetrachloride and ethylene trifluoride may be further included for imparting non-flammability, and fluoro-ethylene carbonate (FEC), propene sulfone (PRS), fluoro-propylene carbonate (FPC), and the like may be further included for improving conservation properties at a high temperature.

The method of manufacturing a lithium secondary battery according to the present invention for achieving the above object may include laminating the negative electrode prepared, separator, and positive electrode in this order to form an electrode assembly, placing the produced electrode assembly in a cylindrical battery case or an angled battery case, and then injecting an electrolyte solution. Otherwise, the lithium secondary battery may be produced by laminating the electrode assembly and impregnating the assembly with the electrolyte solution to obtain a resultant product which is then placed in a battery case and sealed.

As the battery case used in the present invention, those commonly used in the art may be adopted, there is no limitation in appearance depending on the battery use, and for example, a cylindrical shape, an angled shape, a pouch shape, a coin shape, or the like using a can may be used.

The lithium secondary battery according to the present invention may be used in a battery cell used as a power supply of a small device, and also may be preferably used as a unit cell in a medium or large battery module including a plurality of battery cells. Preferred examples of the medium or large device include an electric automobile, a hybrid electric automobile, a plug-in hybrid electric automobile, a system for power storage, and the like, but are not limited thereto.

Hereinafter, the preferred Examples and Comparative Examples of the present invention will be described. However, the following Examples are only a preferred exemplary embodiment of the present invention, and the present invention is not limited thereto.

### EXAMPLES

### Example 1

### 1) Production of Current Collector Having Conductive Layer Formed Thereon

A carbon black conductive material (D50: 100-200 nm) and a CMC binder were mixed in water to produce a slurry for a conductive layer.

The produced slurry for a conductive layer was applied on each of a copper current collector (Cu foil, thickness: 8 μm) and an aluminum current collector (Al foul, thickness: 12 μm) and dried to produce a copper current collector having a conductive layer formed and an aluminum current collector having a conductive layer formed.

### 2) Production of Negative Electrode

A negative electrode active material in which artificial graphite (D50: 20 μm) and silicon oxide (SiO, D50: 4-6 μm) were mixed at a weight ratio of 94:6, a SWCNT conductive material, and a binder (CMC/SBR=1.2/1.5 at a weight ratio) were mixed at a weight ratio of 97.2:0.1:2.7, and water was added thereto to produce a negative electrode slurry.

The produced negative electrode slurry was applied on a copper current collector coated with a conductive layer and dried to form a negative electrode active material layer. This was pressed so that it had an electrode density of 1.7 g/cc, thereby producing a negative electrode.

### 3) Production of Positive Electrode

A lithium nickel cobalt manganese oxide (LiNi_{0.88}Co_{0.10}Mn_{0.02}O₂) positive electrode active material, a carbon black conductive material (D50: 100-200 nm), and a PVdF binder were mixed at a weight ratio of 98.6:0.4:1, and NMP was added to produce a positive electrode slurry.

The produced positive electrode slurry was applied on an aluminum current collector having a conductive layer formed thereon and dried to form a positive electrode active material layer. This was pressed so that it had an electrode density of 3.7 g/cc, thereby producing a positive electrode.

### 4) Production of Full Cell

The produced negative electrode and the produced positive electrode were used, a PE separator was interposed between the negative electrode and the positive electrode, an electrolyte solution was injected, and a pouch type full cell was assembled. The assembled cell was paused at room temperature for 3 to 24 hours to produce a lithium secondary battery.

Here, the electrolyte solution was obtained by mixing a lithium salt, 1.0 M LiPF₆ with an organic solvent (EC:EMC=3:7 vol %) and mixing 2 vol % of an electrolyte additive FEC.

### Comparative Example 1

A negative electrode, a positive electrode, and a lithium secondary battery were produced in the same manner as in Example 1, except that the conductive layer was not formed on each of the copper current collector (Cu foil, thickness: 8 μm) and the aluminum current collector (Al foil, thickness: 12 μm).

### Evaluation Example

### Evaluation Example 1: Scanning Electron Microscope (SEM) Image Analysis of Electrode Cross Section

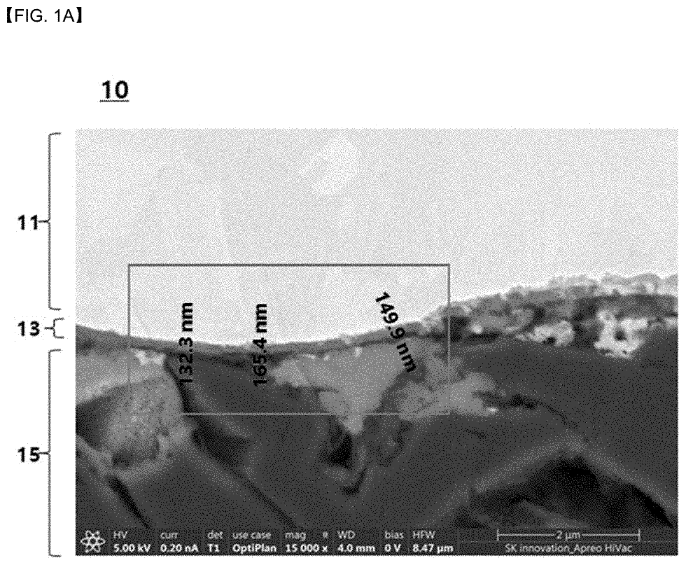

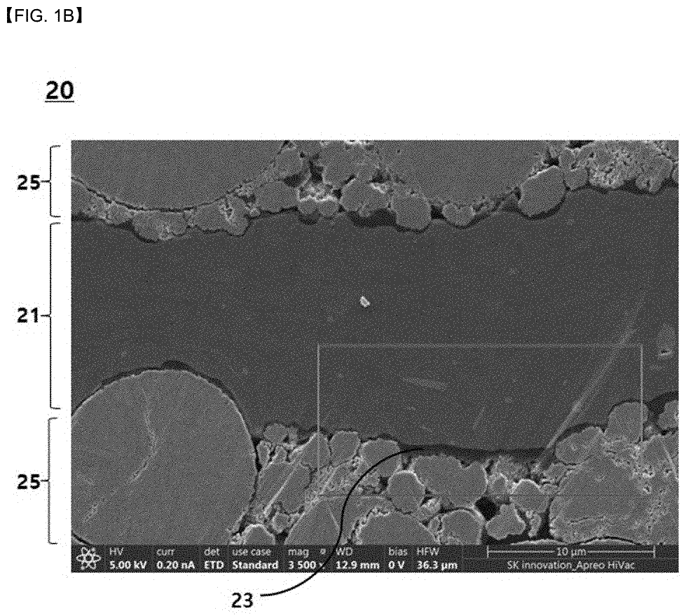

The cell after formation, produced in Example 1 was disassembled, and scanning electron microscope (SEM) image analysis of each cross section of the negative electrode and the positive electrode was performed, and the results are shown in each of FIGS. 1A and 1B.

Referring to FIGS. 1A and 1B, it was confirmed that a conductive layer was formed on each of the positive electrode current collector and the negative electrode current collector.

### Evaluation Example 2: Analysis of Contact Characteristics of Point-Type Conductive Material Particles and Active Material Particles of Conductive Layer and Evaluation of Fast Charge Life

### Example 2

A negative electrode, a positive electrode, and a full cell were produced in the same manner as in Example 1, except that a graphite conductive material having a particle size (D50) described in the following Table 1 was used when the slurry for a conductive layer was produced.

### Review of Contact Characteristics of Conductive Material Particles and SiO Active Material Particles

The shape of the point-type conductive material used in forming the conductive layer of Example 1, the shape of the SiO active material particles, and particle size distribution properties were analyzed, and the contact characteristics of the conductive material particles and SiO active material particles were reviewed.

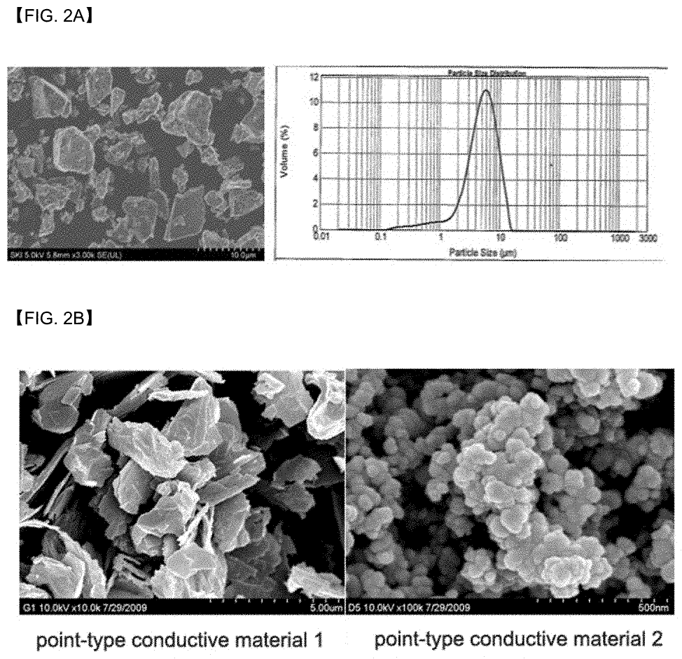

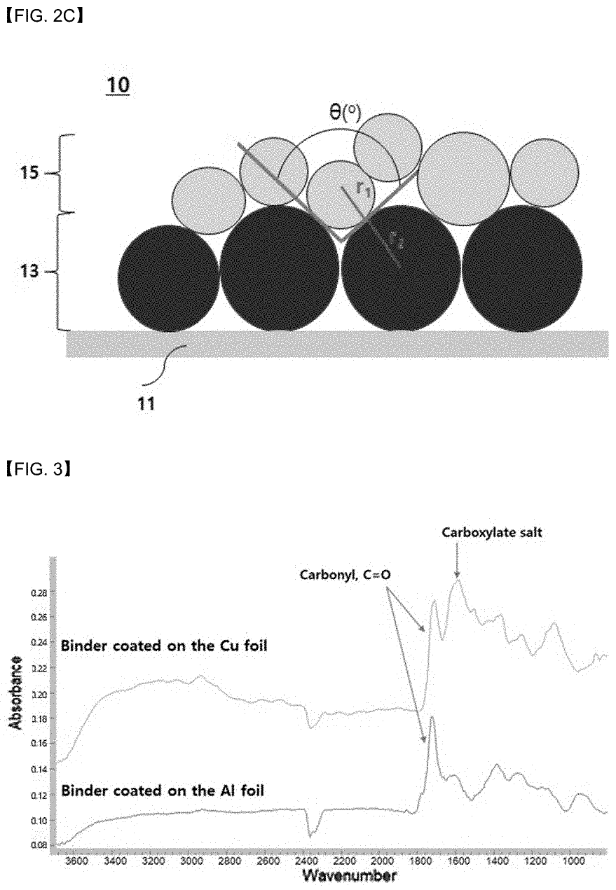

FIG. 2A is a SEM image showing the silicon oxide (Si) particle shape used in Example 1 and a graph showing a SiO particle distribution, FIG. 2B is a SEM image of the point-type conductive material used in the conductive layer (point-type conductive material 1: Example 2, and point-type conductive material 2: Example 1), and FIG. 2C is a schematic diagram showing how the point-type conductive material particles of the conductive layer according to an exemplary embodiment of the present invention and SiO particles are in contact.

In addition, the SiO particle size of Examples 1 and 2 and Comparative Example 1, the CB particle size of the negative electrode conductive layer, and the contact angle between these particles are summarized in the following Table 1, and the contact angle between the particles was calculated by the following Equation 1:

Contact angle θ(°)=2×cos⁻¹(d₂/(d₁+d₂)) [Equation 1]

wherein d₁ is a SiO active material particle size (D50), and d₂ is a point-type conductive material particle size (D50) used in the conductive layer.

### Evaluation of Fast Charge Life

300 cycles were performed on the full cells produced in Examples 1 and 2 and Comparative Example 1, under the following conditions, thereby evaluating the fast charge life, and the results were calculated as a relative scale and are shown in the following Table 1.

i) Charge: fast charge protocol, charge amount: to SOC 80%

ii) Discharge: ⅓ C discharge, discharge amount: to SOC 8%

iii) Temperature: 25° C.

TABLE 1

| | | | | Conductive material | | |
|---|---|---|---|---|---|---|
| | | | | particle size | | |
| | SiO particle size | | | (conductive layer) | | Fast |
| | D10 | D50 | D90 | D50 | Contact angle | charge life |
| | (μm) | (μm) | (μm) | (nm) | (°) | (Relative scale) |
| Example 1 | 2 | 4~6 | 10 | 100~200 | 174.5~178.1 | 1 |
| Example 2 | | | | 8,000 | 96.4~110.3 | 0.9 |
| Comparative | | | | — | — | 0.8 |
| Example 1 | | | | | | |

Referring to Table 1, when an angle of a contact point formed by the point-type conductive material particles of the conductive layer and the active material particles of the active material was 100°-180° (Example 1), the contact between the current collector (foil) and the electrode active material layer and the contact between the active material particles and the point-type conductive material particles were not broken by the point contact of these particles even during contraction and expansion of the active material particles following battery operation, and thus, it was found that an electrical conductivity and a resistance increase may be improved. However, since in Example 2, the contact angle between particles was less than 100°, the results of evaluating a fast charge life were inferior to that of Example 1.

### Evaluation Example 3: Evaluation of Battery Swelling Properties in Full Cell Charge and Discharge

### Analysis of Surface of Current Collector Having Conductive Layer Formed Thereon

The conductive layer on the surface of the negative electrode current collector and the conductive layer on the surface of the positive current collector produced in Example 1 were analyzed by infrared spectroscopy (IR) and the results are shown in FIG. 3.

### Analysis of Spring Back

When the negative electrodes of Example 1 and Comparative Example 1 were produced, the copper current collector was coated with the negative electrode slurry, the coated negative electrode was pressed, vacuum drying (VD) was performed, the thickness of each electrode was measured, and the electrode thickness after VD relative to the pressed electrode thickness was calculated to measure a swelling (%). The measurement results are shown in the following Table 2.

### Analysis of Swelling After Impregnation

When the full cells of Example 1 and Comparative Example 1 were produced, the electrode thickness after electrolyte impregnation was measured, and the electrode thickness after impregnation relative to the electrode thickness after VD was calculated to measure a swelling (%). The measurement results are shown in the following Table 2.

### Analysis of Swelling Difference Between Fully Charged Electrode Thickness and Fully Discharged Electrode Thickness

The produced full cell was subjected to a formation process, and then the cell was discharged to measure the fully discharged electrode thickness and the cell was charged to measure the fully charged electrode thickness, respectively, and the fully charged electrode thickness relative to the fully discharged electrode thickness was calculated to measure each swelling (%). The measurement results are shown in the following Table 2.

TABLE 2

| | | Comparative Example 1 | Example 1 (conductive |
|---|---|---|---|
| | | (common current | layer coating current |
| Negative electrode | | collector) | collector) |
| Spring back | Coating electrode | 203 | 209 |
| | thickness | | |
| | Press electrode | 127 | 124 |
| | thickness | | |
| | Thickness after V/D | 130 | 129 |
| | Swelling (%) | 3.1 | 4.3 |
| Swelling after | Thickness after | 145 | 141 |
| impregnation | electrolyte impregnation | | |
| | Swelling (%) | 15 | 14 |
| Difference in swelling | Fully discharged | 148 | 146 |
| between fully charged | thickness after | | |
| electrode thicknes and | formation | | |
| fully discharged | Swelling (%) | 17 | 18 |
| electrode thickness | Fully charged thickness | 164 | 164 |
| | after formation | | |
| | Swelling (%) | 31 | 34 |
| | Δ | 14% | 16% |

Referring to Table 2, since the conductive layer disposed between the current collector and the active material layer acted as a buffer (buffer effect, increased electrode spring back) of the current collector and the active material from a viewpoint of pore change inside the electrode, it is advantageous for securing pores between the electrode and the current collector during charging. In spite of securing pores, there was a conductive material layer having a relatively high electrical conductivity on the current collector, and thus, the contact between the current collector and the active material particles and the contact between the active material particles may be maintained good. Therefore, an effect of preventing an electrical short circuit and facilitating electron migration to improve fast charging performance may be confirmed. Meanwhile, when a common current collector without a conductive layer was applied during battery discharging (Comparative Example 1), it was confirmed that the swelling degree was maintained at the same level.

Referring to FIG. 3, it was found that the CMC-based binder component used in the conductive layer was formed of carbonyl(C═O), carboxylate salt form. Thus, by using the CMC-based binder, a swelling problem occurring during charging and discharging when the PVdF-based binder was used may be supplemented, and the electrical short circuit of the active material and the current collector may be minimized. Meanwhile, when the SBR-based binder was used, there was a risk of resistance increase so that the conductive layer coating effect of the present invention may be deteriorated, which is thus not preferred.

### Evaluation Example 4: Evaluation of Electrochemical Performance of Cell According to Negative Electrode Conductive Layer Formation

### Examples 3 and 4

A negative electrode, a positive electrode, and a lithium secondary battery were produced in the same manner as in Example 1, except that when the negative electrode slurry was produced, artificial graphite (D50: 20 μm) and silicon oxide (SiO, D50: 4-6 μm) were mixed at the weight ratios described in Table 3.

### Example 5

A negative electrode active material in which artificial graphite (D50: 20 μm) and silicon oxide (SiO, D50: 4-6 μm) were mixed at a weight ratio of 92:8, a SWCNT conductive material, and a binder (CMC/SBR=1.2/1.5 at a weight ratio) were mixed at a weight ratio of 97.1:0.2:2.7, and water was added thereto to produce a first negative electrode slurry.

A second negative electrode slurry was produced in the same manner as the first negative electrode slurry, except that the artificial graphite (D50: 20 μm) and silicon oxide (SiO, D50: 4-6 μm) were mixed at a weight ratio of 96:4.

The produced first negative electrode slurry was applied on a copper current collector coated with a conductive layer and dried to form a first negative electrode active material layer. Subsequently, the produced second negative electrode slurry was applied on the first negative electrode active material layer and dried to form a second negative electrode active material layer.

Other than that, the process was performed in the same manner as in Example 1, thereby producing a negative electrode, a positive electrode, and a lithium secondary battery.

### 1) Evaluation of Electrode Adhesive Strength

The electrode adhesive strength to the negative electrodes produced in Examples 1 and 3 to 5 and Comparative Example 1 was measured by a measurement standard (measuring a force when an electrode was attached to a tape and then detached at an angle of 90°) using an adhesive strength measurement device (IMADA Z Link 3.1). The measurement results are shown in the following Table 3.

### 2) Measurement of Negative Electrode Interfacial Resistance

Each negative electrode resistance was measured for the electrodes produced in Examples 1 and 3 to 5 and Comparative Example 1, and the results are shown in the following Table 3. The measurement conditions are as follows:

i) Measurement equipment: Hioki XF057 Probe unit

ii) Measurement conditions: Current: 100 uA/voltage range: 0.5V

iii) Number of pin contacts: 500

### 3) Evaluation of Fast Charging Time and Fast Charge Life

300 cycles were performed on the full cells produced in Examples 1 and 3˜5 and Comparative Example 1, under the following conditions, thereby evaluating the fast charge life, and the results are shown in the following Table 3.

i) Charge: fast charge protocol, charge amount: to SOC 80%

ii) Discharge: ⅓ C discharge, discharge amount: to SOC 8%

iii) Temperature: 25° C.

TABLE 3

| | Negative electrode | | | | | | |
|---|---|---|---|---|---|---|---|
| | | First | Second | | | | |
| | | negative | negative | Negative | | Fast | Fast |
| | | electrode | electrode | electrode | | charging | charge |
| | Conductive | slurry | slurry | interfacial | Adhesive | time | life |
| | layer | (graphite:SiO | (graphite:SiO | resistance | strength | (min, at | (300 |
| | formation | weight ratio) | weigiht ratio) | (Ohm_cm²) | (N) | 25° C.) | cycles) |
| Comparative | X | 94:6 | — | 0.015 | 0.50 | 36.6 | 82.0% |
| Example 1 | | | | | | | |
| Example 1 | ◯ | 94:6 | — | 0.007 | 0.60 | 31.6 | 85.0% |
| Example 3 | ◯ | 90:10 | — | 0.008 | 0.62 | 29.0 | 82.5% |
| Example 4 | ◯ | 85:15 | — | 0.01 | 0.65 | 27.5 | 80.0% |
| Example 5 | ◯ | 92:8 | 96:4 | 0.008 | 0.58 | 31.0 | 87.0% |

The composition for the negative electrode of the lithium secondary batteries of the examples of the present invention included a negative electrode active material including an active material and a silicon-based active material. Referring to Table 3, it was confirmed that deterioration of life characteristics and fast charging performance by Si application occurred with a conventional electrode structure, and thus, it was difficult to secure a long life. As a Si content increased, a contact area between the current collector and the active material was decreased by Si expansion during charging/discharging to reduce adhesive strength and break a conductive path, thereby increasing resistance. In the examples, a layer coated with conductive carbon was applied on the current collector and an active material layer was applied thereon, thereby increasing adhesive strength and improving resistance properties. In addition, resistance of the positive electrode was decreased to improve resistance even during high-rate charging, and to secure long-term fast charging performance.

In addition, in Example 5, it was analyzed that since a SiO content placed on a negative electrode surface was low as compared with Example 1, SiO deterioration and resistance increase by a side reaction with an electrolyte solution were relatively small as the cycle progresses, thereby improving a fast charge life and a fast charging time.

### Evaluation Example 5: Evaluation of Electrochemical Performance of Cell According to Positive Electrode Conductive Layer Formation

The lithium secondary batteries produced in Example 1 and Comparative Example 1 were charged at a charge C-rate in the following Table 4 at room temperature (25° C.) to measure SOC (%) of the positive electrode inflection time point (inflection point of dV/dQ), and the results are shown in the following Table 4.

TABLE 4

| | | Positive electrode inflection point time _SOC(%) | |
|---|---|---|---|
| | | Example 1 | Comparative Example 1 |
| Charge C-rate | | Charging depth based on | Charging depth based on |
| (at 25° C.) | | positive electrode (SOC, %) | positive electrode (SOC, %) |
| 0.75 | C | 76.5 | 69.0 |
| 1 | C | 70.2 | 54.3 |
| 1.25 | C | 55.4 | 47.2 |
| 1.5 | C | 52.2 | 43.5 |
| 1.75 | C | 49.2 | 41.0 |
| 2 | C | 44.9 | 37.9 |
| 2.25 | C | 39 | 31.3 |
| 2.5 | C | 36.1 | 26.7 |
| 2.75 | C | 33 | 20.5 |
| 3 | C | 26.7 | 16.0 |

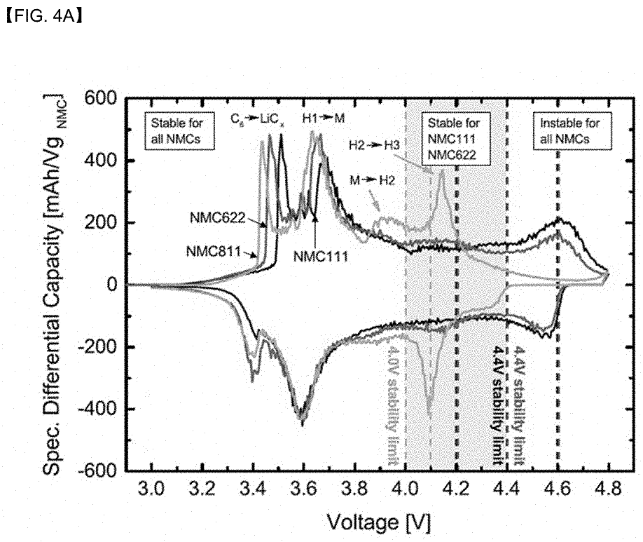

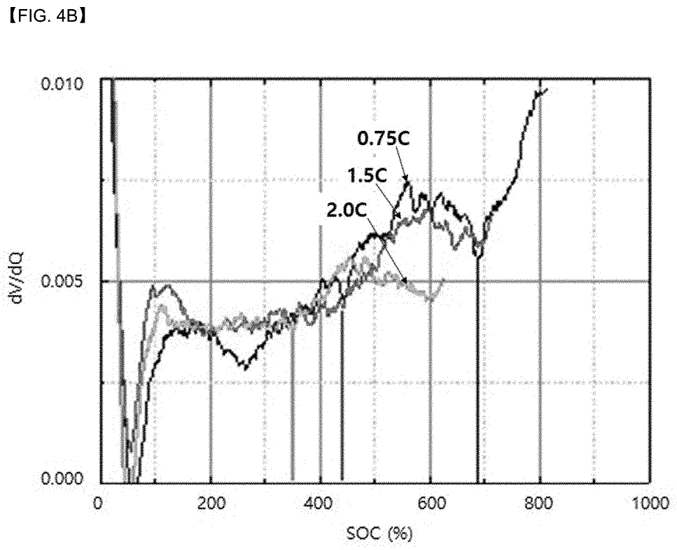

Referring to FIGS. 4A and 4B, it was analyzed that as the Ni content of the positive electrode active material increased, the structural stability of the positive electrode decreased, and the time point of structural change (M→H2→H3) of the positive electrode was advanced, and also, as the charge C-rate increased, the structural change time point was advanced by resistance increase.

Referring to Table 4, in Example 1, it was confirmed that the current collector on which the conductive layer was formed was applied simultaneously to the positive electrode and the negative electrode, respectively, when the lithium secondary battery was produced, and thus, the resistance of the positive electrode to apply current was reduced to delay the structural change (phase transition) of the positive even when the high Ni-based positive electrode active material was used, and the fast charge characteristics were improved by the phase transition voltage change at a high rate charge, which has never been expected before. It was analyzed that the improvement effect was further maximized when the high Ni-based positive electrode active material having a Ni content of 80% or more was used.

Although the exemplary embodiments of the present invention have been described above, the present invention is not limited to the exemplary embodiments but may be made in various forms different from each other, and those skilled in the art will understand that the present invention may be implemented in other specific forms without departing from the spirit or essential feature of the present invention. Therefore, it should be understood that the exemplary embodiments described above are not restrictive, but illustrative in all aspects.

### DETAILED DESCRIPTION OF MAIN ELEMENTS

10: negative electrode

11: negative electrode current collector

13: first coating layer of negative electrode (negative electrode conductive layer)

15: second coating layer of negative electrode (negative electrode active material layer)

20: positive electrode

21: positive electrode current collector

23: first coating layer of positive electrode (positive electrode conductive layer)

25: second coating layer of positive electrode (positive electrode active material layer)

1. A negative electrode for a secondary battery comprising:
a current collector;
a first coating layer including a point-type conductive material and a binder, formed on the current collector; and
a second coating layer including a silicon-based active material, formed on the first coating layer.

2. The negative electrode for a secondary battery of claim 1, wherein
a ratio between an average particle diameter (D50) of the point-type conductive material and an average particle diameter (D50) of the silicon-based active material is 1:60 to 1:20.

3. The negative electrode for a secondary battery of claim 1, wherein
the average particle diameter (D50) of the point-type conductive material is 100 to 200 nm.

4. The negative electrode for a secondary battery of claim 1, wherein
the point-type conductive material includes at least one selected from carbon black and graphite-based materials.

5. The negative electrode for a secondary battery of claim 1, wherein
the binder is carboxymethyl cellulose, a carboxymethyl cellulose derivative, polyvinyl alcohol, polyacrylic acid, a polyacrylic acid derivative, or a combination thereof.

6. The negative electrode for a secondary battery of claim 1, wherein
the first coating layer has a thickness of 0.05 to 2 μm.

7. The negative electrode for a secondary battery of claim 1, wherein
the average particle diameter (D50) of the silicon-based active material is 2 to 10 μm.

8. The negative electrode for a secondary battery of claim 1, wherein
the second coating layer further includes a carbon-based active material, a binder, and a conductive material.

9. The negative electrode for a secondary battery of claim 1, further comprising:
a third coating layer including a silicon-based active material, formed on the second coating layer.

10. The negative electrode for a secondary battery of claim 9, wherein
a content of the silicon-based active material in the second coating layer (wt % with respect to a total weight of the second coating layer) is higher than a content of the silicon-based active material in the third coating layer (wt % with respect to a total weight of the third coating layer).

11. A secondary battery comprising: the negative electrode of claim 1; a positive electrode; a separator disposed between the negative electrode and the positive electrode; and an electrolyte solution.

12. The secondary battery of claim 11, wherein
the positive electrode includes:
a current collector;
a first positive electrode coating layer including a point-type conductive material and a binder, formed on the current collector; and
a second positive electrode coating layer including a Ni-based active material represented by the following Chemical Formula 1, formed on the first positive electrode coating layer:
LiₐNiₓCo_{y}Mn_{1-x-y}O₂ [Chemical Formula 1]
wherein a, x, and y satisfy: 0.9≤a≤1.05, 0.80<x≤1, 0≤y<0.2.

13. The secondary battery of claim 12, wherein
a ratio between an average particle diameter (D50) of the point-type conductive material and an average particle diameter (D50) of the N-based active material included in the positive electrode is 1:60 to 1:20.
